(19) United States
(12) Patent Application Publication
(10) Pub. No.: US 2022/0114856 A1
(43) Pub. Date: Apr. 14, 2022

(54) SYSTEM AND METHOD FOR MONITORING PERFORMANCE OF SPORTS BETTING ACTIVITY

(71) Applicant: Juice Integration, Inc., New York, NY (US)

(72) Inventor: Ricky GOLD, New York, NY (US)

(73) Assignee: Juice Integration, Inc., New York, NY (US)

(21) Appl. No.: 17/494,591

(22) Filed: Oct. 5, 2021

Related U.S. Application Data
(60) Provisional application No. 63/089,899, filed on Oct. 9, 2020.

(51) Int. Cl. G07F 17/32; G06Q 50/34

(52) U.S. Cl. CPC G07F 17/323; G06Q 50/34; G07F 17/3288

(57) ABSTRACT

A system for monitoring performance of sports betting activity of a bettor across a plurality of on-line sports betting operations (OSBOs), comprises a computer system, the computer system comprising digital data storage and one or more processors. The computer system is programmed and configured to communicate with a bettor device over a data link, for example, over the Internet. The computer system is further programmed and configured to receive, and store in the digital data storage, a first set of login credentials for a first OSBO and a second set of login credentials for a second OSBO, the first set of login credentials and second set of login credentials associated with the bettor. The computer system is further programmed and configured to log in to the first OSBO using the first set of login credentials and to log in to the second OSBO using the second set of login credentials; then to retrieve, and store in the digital data storage, combined betting information comprising live betting information and historical betting information, from the first OSBO and second OSBO, the live betting information and historical betting information associated with the bettor. The computer system is further programmed and configured to transmit at least some of the combined betting information over the data link for display on the bettor device.

### CROSS-REFERENCE TO RELATED APPLICATIONS

This application claims the benefit of U.S. Provisional Patent Application Ser. No. 63/089,899 filed Oct. 9, 2020, which is incorporated herein by reference in its entirety for all purposes.

### STATEMENT REGARDING PRIOR DISCLOSURES BY THE INVENTORS OR JOINT INVENTORS UNDER 37 C.F.R. 1.77(b)(6)

System(s) and method(s) for monitoring performance of sports betting activity were publicly disclosed, used, sold and/or offered for sale by the applicant/assignee Juice Integration, Inc. less than one year before the filing date of the present application, under the name and mark JUICE REEL. The applicant/assignee obtained the system(s) and method(s) for monitoring performance of sports betting activity directly or indirectly from the named inventors of the present application. Said JUICE REEL system(s) and method(s) is/are “inventor-originated disclosures” within the exceptions defined in 35 U.S.C. 102(b)(1).

### FIELD AND BACKGROUND OF THE SUBJECT TECHNOLOGY

The subject technology relates to systems and methods for monitoring and analyzing the performance of a sports bettor over multiple sports betting operations.

Currently, numerous sports betting opportunities are available to the sports bettor. Sports betting operations may operate on-line and offer bettors the opportunity to bet on the outcomes of numerous competitive sports. On-line betting is available from several operators for sports including football, baseball, basketball, soccer, tennis, bowling, handball, hockey, golf, boxing, mixed martial arts, cricket, cycling, darts, golf, motorsports, rugby, and e-sports.

An on-line sports betting operation will typically maintain account-specific records and statistics of bets placed (both historical and bets on future events), wins/losses, payouts, and overall performance of the specific account. As is usual with websites, an account on a given on-line sports betting operation will be associated with user credentials for logging into the account (e.g., user ID, password, challenge questions, and/or other tokens).

Many sports bettors have accounts with multiple sports betting operations and may use sophisticated strategies to maximize their returns.

There is a need for an improvement in the operation of computerized betting systems, specifically, new systems and methods to accumulate and analyze the sports betting activity and performance of a given sports bettor over multiple on-line sports betting operations. Even outside of the sports betting realm, no software system exists that can use multiple sets of user credentials to initiate logins to the associated multiple on-line accounts simultaneously.

### SUMMARY OF THE SUBJECT TECHNOLOGY

According to an aspect of the subject technology, a mobile device is configured and programmed (i.e., with a downloaded app) to communicate and interoperate with a server over the Internet, to retrieve and display information concerning open and historical bets placed by the user on one or more online betting operations. The device and server are configured and programmed to execute several phases of registration, bet data retrieval, bet data analysis, and bet data display, as will be disclosed in further detail. The system may retrieve, store, aggregate, and analyze data from multiple online betting operations to present the user with a useful and comprehensive view of current and historical betting positions and results. Thereby, the operation of these computerized betting systems is improved.

The subject technology is an improvement in the functioning of on-line wagering technology and the computers and mobile devices utilized for that purpose. Various aspects of the improvement include aggregating a bettor's current and/or historical sports bets across numerous on-line betting operations into a single convenient system; also, calculating and presenting estimated values of current sports bets across numerous on-line betting operations.

According to an aspect of the subject technology, a system for monitoring performance of sports betting activity of a bettor across a plurality of on-line sports betting operations (OSBOs), comprises a computer system, the computer system comprising digital data storage and one or more processors. The computer system is programmed and configured to communicate with a bettor device (for example, a smartphone executing a custom app) over a data link, for example, over the Internet. The computer system is further programmed and configured to receive, and store in the digital data storage, a first set of login credentials for a first OSBO and a second set of login credentials for a second OSBO, the first set of login credentials and second set of login credentials associated with the bettor. The computer system is further programmed and configured to, in response to a single request from the bettor device, log in to the first OSBO using the first set of login credentials and to log in to the second OSBO using the second set of login credentials; then to retrieve, and store in the digital data storage, from the first and second OSBOs, combined betting information comprising live betting information and historical betting information associated with the bettor. The computer system is further programmed and configured to transmit at least some of the combined betting information over the data link for display on the bettor device.

According to a further aspect of the subject technology, a method for monitoring performance of sports betting activity of a bettor across a plurality of on-line sports betting operations (OSBOs), comprises the following steps: receiving and digitally storing a first set of login credentials for a first OSBO, the first set of login credentials associated with the bettor; receiving and digitally storing a second set of login credentials for a second OSBO, the second set of login credentials associated with the bettor; in response to a single command from the bettor device, logging in to the first and second OSBOs using the first and second sets of login credentials respectively, and retrieving from the first and second OSBOs and digitally storing live betting information and historical betting information, resulting in stored combined betting information comprising live betting information and historical betting information from the first OSBO and second OSBO; transmitting at least some of the combined betting information to a bettor device over a data link for display on the bettor device.

It should be noted that one single trigger (i.e. the click of one button, or a keystroke) initiates the logging into the first and second (and potentially more) OSBO simultaneously, and thus the subsequent extraction and storage of the relevant information from the multiple independent sources occurs simultaneously, or practically simultaneously. The subject technology's usage of one trigger to initiate multiple simultaneous logins to multiple independent information storage systems and subsequent information extraction is a paramount aspect of the technology's uniqueness.

### BRIEF DESCRIPTION OF THE DRAWINGS

FIG. 1 is a schematic view of a system including a mobile device and computer system in data communication over the Internet for interoperability according to an embodiment of the subject technology.

FIG. 2 is a schematic view of a system including a mobile device and multiple computer systems in data communication over the Internet for interoperability according to an embodiment of the subject technology.

FIG. 3 is a flow diagram of an embodiment of the subject technology.

Spanning FIGS. 4A-4D is a flow diagram of in-app flow from the user's perspective in an embodiment of the subject technology.

FIG. 5 is a high-level schematic diagram of an embodiment of the subject technology.

FIG. 6 is a high-level schematic diagram of an embodiment of the subject technology.

### DETAILED DESCRIPTION OF THE SUBJECT TECHNOLOGY

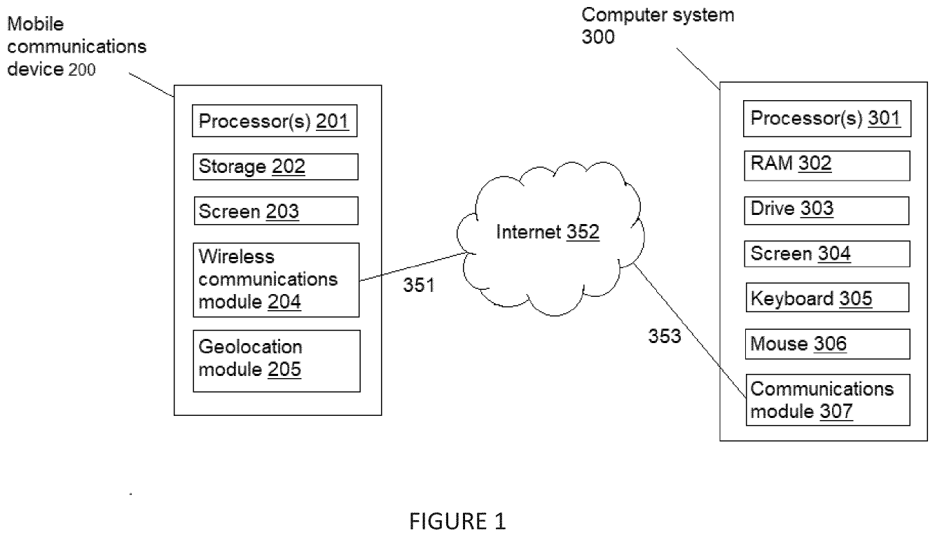

As shown for example in FIG. 1, mobile communication device 200 is a programmable computing device comprising one or more processors 201, operably associated with digital memory storage 202 for storing data on the device 200, a user interface screen 203 for presenting information and receiving information from a user, a wireless communications module 204 (for example a cellular radio) for connecting wirelessly to one or more cellular communication towers and/or the Internet, and a geolocation module 205 (for example, a GPS module) for determining the current location of device 200. Mobile communication device 200 may be, for example, a smart device, smartphone, smart tablet, or other mobile device having similar functionality, known to the art.

According to a further aspect of an embodiment of the subject technology, as shown in FIG. 1, a computer system 300 is provided. Computer system 300 is programmable for data acquisition, storage, processing and output, according to the present disclosure. Computer system 300 preferably comprises one or more one or more processors 301, operably associated with digital memory storage for short-term (e.g. RAM 302) or long-term (e.g. fixed disk drive or solid state drive 303) storage of data on the device 200, a user interface screen 304 for presenting information and receiving information from a user, a keyboard 305 and mouse 306 for receiving information from a user, a digital communications module 307 (for example a cellular radio or network card) for communicating with other digital devices, ultimately via the internet, and may further be operably associated with other computing peripheral devices such as printer(s), scanner(s), etc. as known in the art.

Device 200 and computer system 300 are in data communication contact, at least part of the time, and can mutually send, receive and communicate digital data through a data link, which may be comprised of one or more data connection segments, for example, a cellular data communication segment 351 between device 200 and the internet 352, and a wired or wireless data communication segment 353 from the internet 352 to computer system 300. Device 200 and computer system 300 are programmed and configured to interoperate and implement the features and functions described in more detail herein. Both device 200 and computer system 300 have digital memory storage, as described above, and the data described in the embodiments may be stored on the device 200, on system 300, or on both, as appropriate. It should be understood that any computer system 300 may be implemented as a physical system or as a virtual private server residing in the cloud.

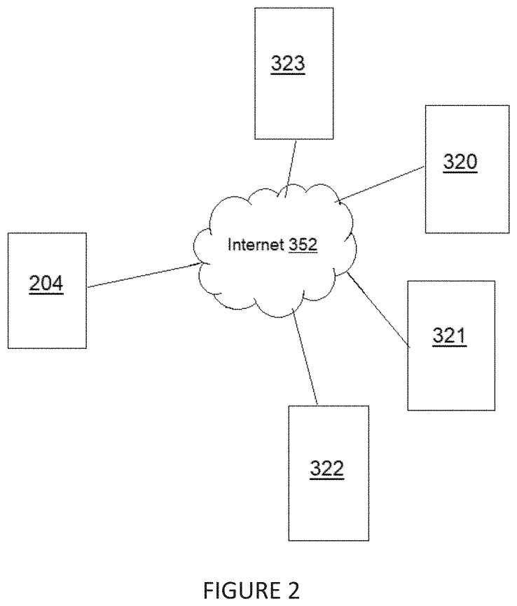

As seen for example in FIG. 2, according to an aspect of an embodiment of the subject technology, mobile device 200 is in data communication contact with computer systems 320, 321, 322, 323 via internet 352. Computer systems 320, 321, 322, 323 may be configured as computer system 300, described above, and may be virtual private servers. (It should be understood that any of computer systems 320, 321, 322, 323 may be implemented as a physical system or as a virtual private server residing in the cloud.)

In this embodiment, computer systems 321, 322 are separately and independently programmed, configured and operated to operate on-line sports betting operations (“OSBOs”). Each OSBO has a plurality of user accounts corresponding to sports betting users, and each account is separately associated with a set of credentials (e.g., user ID, password, challenge questions, and/or other tokens) for logging in to the respective accounts via a web page, mobile app, or other such means. Each OSBO stores information concerning bets and sporting events, associated with its users, and is configured to permit users to log in over the Internet to maintain their accounts, place bets, and retrieve information about open and historical bets. For these and other purposes, systems 321, 322 are configured to respond to requests and transmit web pages in standard markup languages (for example HTML and/or JSON).

In an embodiment, optional computer system 323 is separately and independently programmed, configured and operated to store live and/or historical data concerning sports events (for example, the current score and/or final score of a basketball game) and live and/or historical data concerning betting odds on sports events, and communicate the data upon request to devices and systems connected to system 323 via internet 352, by for example standard markup languages (for example HTML and/or JSON).

Mobile device 200 is used by a sports bettor and is programmed, configured and operated to act as a front-end and user interface for the present system and method, for as described below. Mobile device 200 may be a smart phone, tablet, or the like, and the present functionality may take the form of a downloadable app. (It should be understood that the front-end and user interface could also be implemented as a web page accessible by an Internet-connected desktop or laptop computer (not shown in the figures), rather than as a mobile device app, and such implementation is within the scope of the subject technology.)

In this exemplary embodiment, the sports bettor has a first account with a first OSBO operated on first computer system 321 which is associated with a first set of credentials, and a second account with a second OSBO operated on second computer system 322 which is associated with a second set of credentials.

Computer system 320 is programmed, configured and operated to function as a back-end server for the present system and method, and to interoperate with mobile device 200, and computer systems 321, 322, 323 as described below.

According to an embodiment, mobile device 200 and computer system 320 are programmed, configured and operated to communicate, cooperate and interoperate to carry out a method of acquiring, analyzing, and displaying sports betting data and related information from computer systems 321, 322 and 323.

The usage of the system and method of the subject technology comprises a registration phase; a bet data acquisition phase; a bet data analysis phase; a bet data display phase.

In the registration phase, the user uses mobile device 200 to enroll an account with the system, including the usual identifying information (e.g., name, address, phone number, user ID, password) and information for one or more OSBO websites, including the user's OSBO user credentials on the OSBO websites. The OSBO user credentials are preferably encrypted and are stored in the data storage of computer system 320, in for example a database table. (Naturally, the user may edit his account details and add/remove OSBOs using the device 200 at any time.)

Having created an account and provided OSBO user credentials, the user uses mobile device 200 to issue a “refresh” command to the system, which triggers the bet data acquisition phase. (Additionally, the system 320 may be configured to periodically execute the bet data acquisition phase for one or more registered users, without being triggered by the users.) In this phase, the system 320 uses the provided OSBO user credentials and connects with the OSBO websites via the Internet, logging in to each one using the provided OSBO user credentials. (It should be noted that a single “refresh” or similar user operation on the device 200 causes system 320 to log in to all the user's OSBOs practically simultaneously.) The system 320 is programmed and configured to recognize the OSBO and refer to OSBO-specific system-stored instructions for navigating the OSBO to retrieve pages of interest. (It should be understood that each OSBO could operate differently from other OSBOs, and the system will be configured specifically to support each specific OSBO.) Particularly, in this phase, the OSBO web pages that display “open bets” and “historical bets” (i.e., closed bets) are navigated to by system 320, and the HTML and/or JSON of the pages are retrieved and stored in the data storage of system 320. Any previously-stored open bets (i.e., open bets that were added in a previously-run bet data acquisition phase) that are now closed according to the OSBO are updated in the system as being closed. It should be appreciated that in this embodiment, the user of device 200 can with a single “trigger” (e.g., a single icon click or dragging/pulling down the screen) cause system 320 to retrieve the data from all of the user's registered OSBOs.

More generally, the subject technology may be applied to on-line services and the like other than OSBOs. Viewed more generally, a computer system stores a first set of credentials and a first set of navigation instructions associated with a first on-line service, and stores a second set of credentials and a second set of navigation instructions associated with a second on-line service. Upon receiving a request from a remote device, over a data link, the computer system, simultaneously or nearly simultaneously, logs into each on-line service using the respective set of credentials for that on-line service, navigates and parses data received from each on-line service according to the respective navigation instructions for that on-line service. The parsed data can be normalized and stored in a single database table.

System 320 is programmed and configured to execute the foregoing steps for each OSBO set up by the user in the registration phase, so that at the conclusion of this phase, the open bets and historical bets placed on all of the user's OSBOs have been retrieved and stored in system 320.

In a following bet data analysis phase, system 320 is programmed and configured to perform operations using the stored “open bets” and “historical bets” pages retrieved from the OSBOs. For example, in this phase, the retrieved pages are analyzed by system 320 and data of interest is extracted and stored in the digital storage of the system, the data being associated with the user and an OSBO. The system is programmed and configured to extract and reformat for storage a variety of OSBO information, using OSBO-specific system-stored instructions. Broadly speaking, the OSBO information can be categorized as “bet-level information” and “event-level information” for each bet.

Bet-level information includes the information related to the wager contract, including the ticket number, the date the bet was placed, the amount at risk, the amount that can be won, the structure of the underlying event (for example, a straight bet, parlay, teaser, action reverse or round robin), the status of the bet (e.g. open, cancelled or closed), the date the bet is closed, the amount won/lost, and the net amount won/lost (after fees).

Event-level information corresponds to the event that is being bet on. In an embodiment, event-level information can fall into one of three categories that are stored in separate database tables of the system: standard events (outcome depends on a team winning the event or covering the point spread), over-under events (or “totals wager,” outcome depends on the total number of points scored being over/under a given amount (the “moneyline”)), and proposition events that do not fit into the proceeding two categories. Event-level information for a standard event includes a sport ID to identify the sport, the team being bet on, the opposing team, the date of the event, the point spread if any, and the OSBO fee (also known as the house edge, margin or “vig”). Event-level information for an over-under event includes the date of the event, the teams, the moneyline, bought points, the duration of the bet (for example, the first quarter of a football game, or the second half, or the entire game) and the user's wager (over or under the moneyline). Event-level information for a proposition event includes the date of the event, a description, and the OSBO fee. In the bet data analysis phase, the stored HTML and/or JSON pages retrieved from the OSBOs are parsed to determine the bet-level information and event-level information for all bets reflected in the stored pages, and the information is populated into database tables associated with the user and OSBO. Thus, by the completion of the bet data analysis phase, the system has stored in its digital storage the bet-level and event-level information for all the open and historical bets for the user for all the OSBOs.

Elements of the bet-level and event-level data are normalized and standardized for storage and analysis. For example, team names and bet types are standardized so that bets placed on different OSBOs but involving the same teams/bet types will be properly recognized and stored by system 320.

After completion of the bet data analysis phase, the device 200 and system 320 are programmed and configured to interoperatively execute a bet data display phase, to aggregate and format data for display, perform calculations, and/or graph the data and display the results, on the screen of device 200, to help the user understand his open bet position and historical bet history and performance. Many such useful calculations and displays are possible with the subject technology, for example, the user's current betting positions over all OSBOs; the amount won/lost by the user over a given time period; the user's current amount at risk; the user's historical amount at risk; the user's best/worst/most-frequent teams; and the user's overall performance.

Relevant to the bet data display phase, in an embodiment, system 320 is programmed and configured to communicate with computer system 323 (which stores and delivers live and/or historical data concerning sports events), to retrieve relevant data that may be combined and displayed along with the user's individual bet data. For example, when displaying a bet concerning a given football game while the game is in progress, system 320 may be programmed and configured to contact system 323 to retrieve the status of the game (including, for example, the sport, the team(s) playing, the score, who has possession, how much time remains/has elapsed on the clock, the weather, and the quarter) and display this information along with the user's bet on the same game. Information retrieved from system 323 may be stored and/or cached in system 320 for later use.

In embodiments of the subject technology, device 200 is programmed and configured to switch between a display of open bet data and a display of historical bet data with a single click or gesture on device 200.

According to a further, optional, aspect of the subject technology, in an embodiment, system 320 is programmed and configured to communicate through a two-way data link with live-odds server 400. System 320 requests live-odds data from live-odds server 400, which responds with the requested live-odds data, over the data link. Live-odds data is data concerning betting opportunities being offered while a game or event is in progress. For example, it may be the case that during a Giants v. Jets football game, a sportsbook offers “Giants +6” and “Jets −6” to their customers as a potential mid-game bet on the final outcome. Other examples of such live betting opportunities include different events that could be bet on such as a (1) a team to win the game (2) a team to cover the spread (3) a team to score a certain amount of points (4) a player to accrue a certain amount of statistics (5) and any other in-play offering that a sports bookmaker makes available to a customer. In this optional aspect of the subject technology, system 320 is programmed and configured to retrieve relevant live-odds data for a game in progress from live-odds server 400, and to retrieve relevant game status data from server 323, and in conjunction with some or all of the stored bet-level and event-data for that game, calculate, store and display an estimated bet value. An estimated bet value may be a function of one or more of the event-level data items for the event, one or more of the bet-level data items for the user's bet, one or more live-odds data items, and one or more game status data items.

A non-limiting example of calculation of an estimated bet value is as follows. In this example, according to the event-level and bet-level data stored in digital storage of system 320, a bettor has placed a bet with an OSBO on a Giants-Jets football game, specifically, before the game commenced, the bettor wagered $100 on Giants to win, 3:1 odds. Thus, the bettor's amount at risk is $100 and if the Giants win the game, will win $300 less the OSBO fee (the “vig”). After the game has commenced, system 320 retrieves live-odds data from live-odds server 400 indicating that a sports bookmaker (which may be the same OSBO, or a different OSBO, or some other sports bookmaker) is currently offering a mid-game wager of Giants to win, 2:1 odds. This indicates that the odds at that point in time are more favorable to the bettor than originally thought. System 320 calculates an expected bet value which will be a positive number because the odds have shifted in the bettor's favor. The expected bet value will be a function of (at least) the amount at risk, the amount that can be won, the OSBO fee, and the new odds (from the live-odds data).

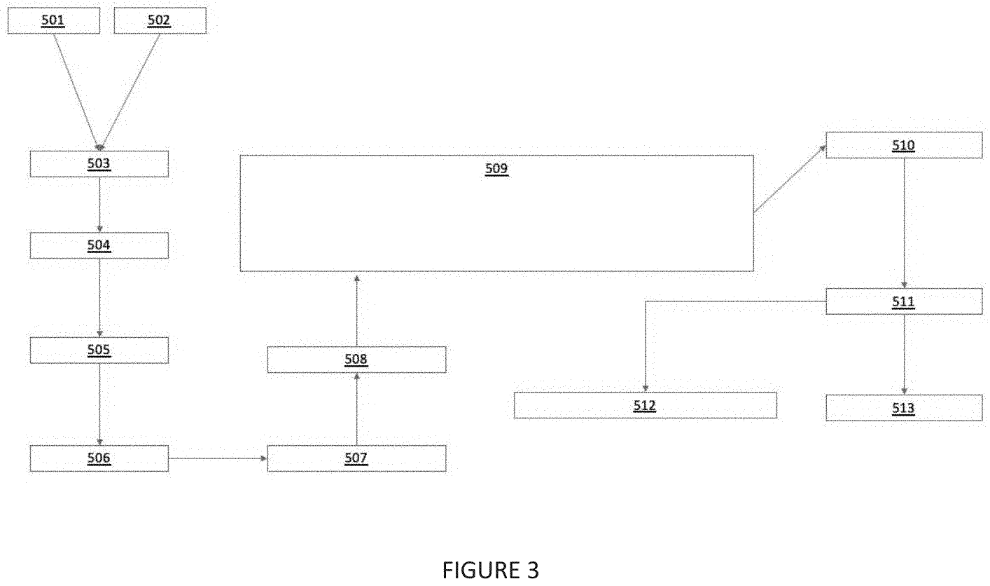

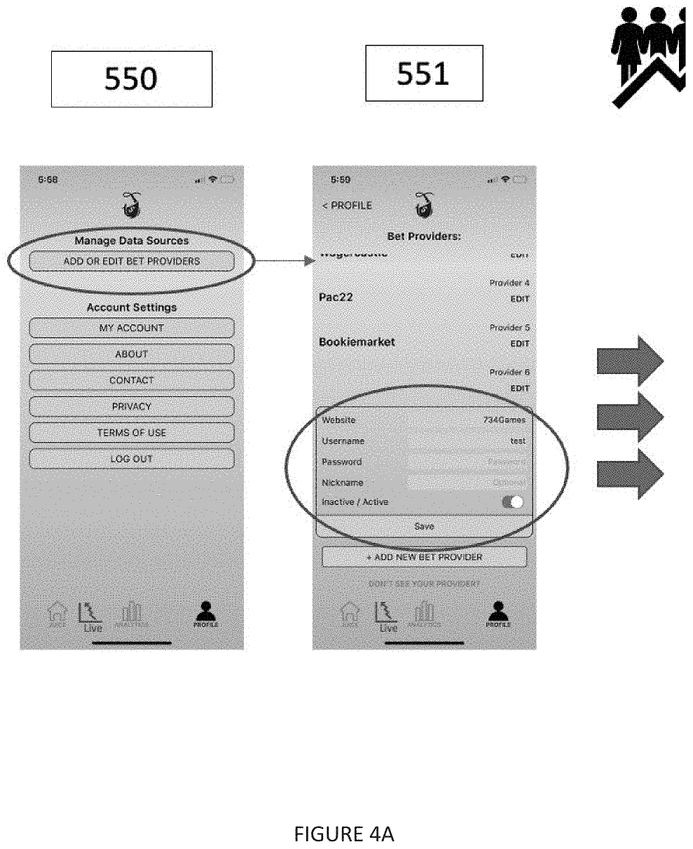

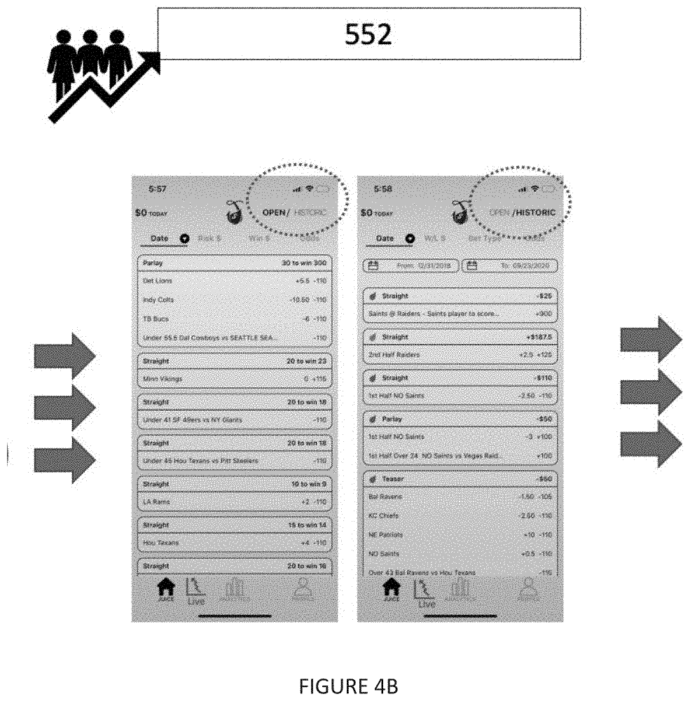

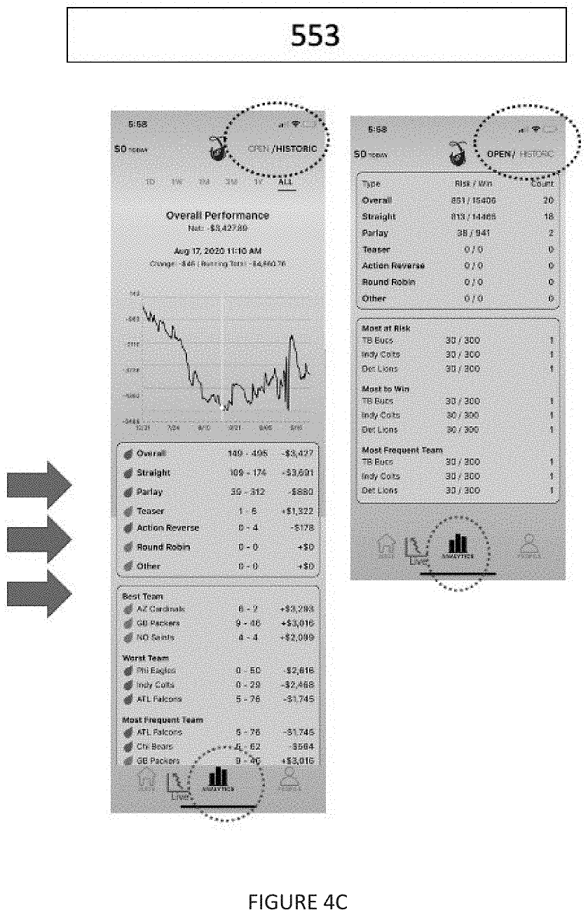

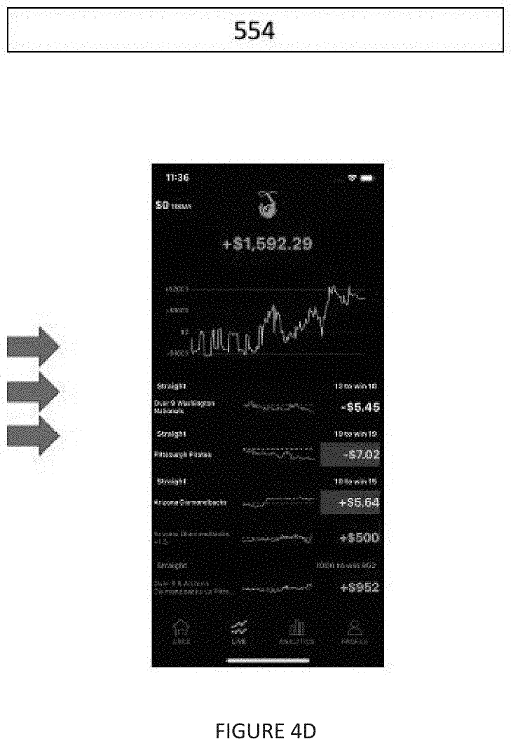

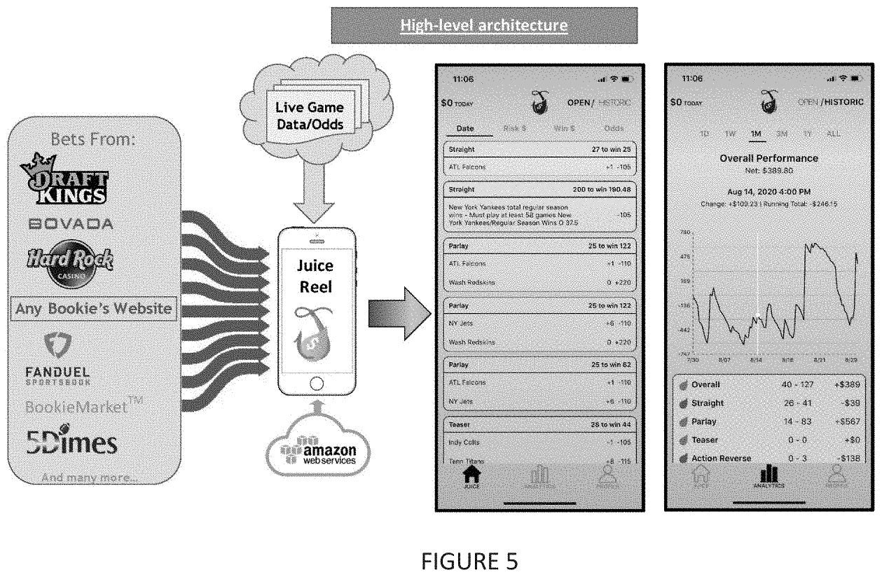

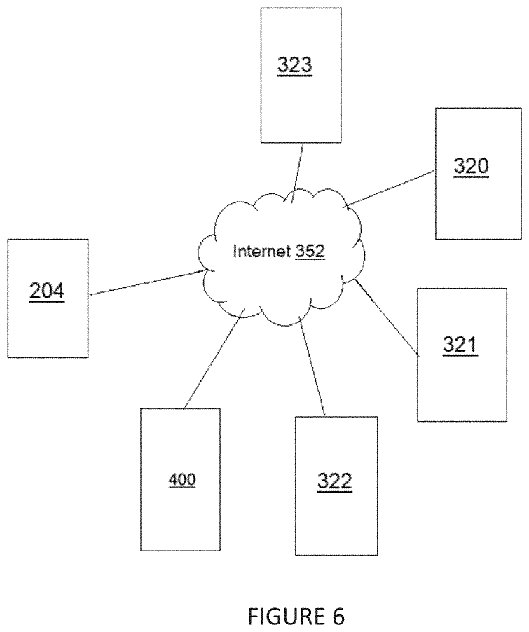

FIG. 3 shows data/code flow of a non-limiting embodiment of the subject technology, particularly the assignee's JUICE REEL service. For clarity, the text of FIG. 3 is as follows.

501: Database table of websites that we support

502: Code that comprises a supported website

503: User selects a website and provides website credentials

504: Website credentials are stored and encrypted in database table

505: User triggers “refresh” within app to initiate webscraping of all website+credentials provided

506: Network requests are used to log into each website simultaneously with the given credentials

507: After logging into the site, the code navigates to the webpage(s) that contains “open bets” and the webpage(s) that contain “historic bets”

508: The HTML/JSON found on the webpage is isolated and prepared for parsing/cleaning and subsequent insert into our database

509: A bet is dependent on the outcome of one or many events. Our data model is structured in a fashion that understands a bet contains financial/contractual information and is dependent on one or many events underlying events. The HTML/JSON found on the webpage is organized by extracting the higher level “bet” information and underlying “event” information. The bet-level information is the contractual information regarding the bet. Bet Level Attributes of Importance: the date is was placed, the amount at risk, the amount that can be won, the structure of the underlying events (i.e. straight bet, parlay, or teaser, etc.), the date the bet is closed, how much was won/lost, etc. The event level information is event(s) being bet on. We categorize the events in 3 categories in 3 distinct database tables that roll up into the the bet-level table through relational identifiers. Standard events—events where the outcome is dependent on a team winning a game/covering a spread. Standard event attributes of importance: Team Bet on, opposing team, date of event, spread, vig. Over-Under events—events where the outcome is dependent on a total number of points being over/under a particular number. Over-Under event attributes of importance: date of event, teams involved in game, the particular number that is being bet over or under on, does the user hope for over or under that particular point value, etc. Prop events—events that do not fall under the above two categories. Prop event attributes of importance: date of event, description, vig, etc. The above attributes of importance are isolated, parsed/cleansed, and subsequently insert into our database bet table and event(s) tables.

510: Team names from the various scraped website are standardized.

511: The bets, which our now in our database, are passed to the users' device and displayed for them to see.

512: External data relating to real-time game information (such as scores) and real-time betting information (such as potential bets sportsbooks offer to their customers) are synthesized with bet-level information. All three of the aforementioned are inputs to formulas that are run, in real-time, to deduce what a given wager is worth at a current point in time.

513: Calculations are run based on a users' bets (such as amount won/lost over different timeframes, best/worst teams, amount at risk, etc.) and the outputs are sent and displayed for the user.

FIGS. 4A-4D show in-app flow of a non-limiting embodiment of the subject technology, particularly the assignee's JUICE REEL service. For clarity, the text of FIGS. 4A-4D is as follows.

550: User presses “Add or Edit Bet Provider” which lets them connect a site we support.

551: User selects which website he bets on, user inputs his username and password to that website, and presses save. With those credentials, our code logs into the website and scrapes their bet data off the website. Our code parses/cleanses the HTML/JSON data to extract and store the information that we care about (i.e. what team is bet on, the risk amount, the odds, etc.)

552: We display a user's open bets (bets that haven't occurred yet) and closed bets (bets that occurred and won/lost). The toggle on the top right lets the user instantly switch between open and closed bets. The other buttons on top are filters/sorting buttons. All of the data in the center of the screen are the user's bets.

553: Based on the user's bets, we show them analytics on their open bets and analytics on their closed bets. The toggle on the top right lets the user instantly switch between open-bet analytics and closed-bet analytics. The 1D, 1W, 1M. Etc buttons show performance for the past 1 Day, 1 Week, 1 Month etc.

554: User selects the “Live” button which takes the bet data (and all its attributes) from “Bullet 3” and pairs it with a feed of “live odds data” and “live game data”. Data from each element of the pairing is used as inputs to various formulas, with the result of such formulas being the what the wager is nominally worth at a given time.

While specific embodiments of the invention have been shown and described in detail to illustrate the application of the principles of the invention, it will be understood that the invention may be embodied otherwise without departing from such principles. It will also be understood that the present invention includes any combination of the features and elements disclosed herein and any combination of equivalent features. The exemplary embodiments shown herein are presented for the purposes of illustration only and are not meant to limit the scope of the invention.

What is claimed is:

1. A system for monitoring performance of sports betting activity of a bettor across a plurality of on-line sports betting operations (OSBOs), comprising:
a computer system, the computer system comprising digital data storage and one or more processors;
the computer system programmed and configured to communicate with a bettor device over a data link;
the computer system further programmed and configured to receive, and store in the digital data storage, a first set of login credentials for a first OSBO and a second set of login credentials for a second OSBO, the first set of login credentials and second set of login credentials associated with the bettor;
the computer system further programmed and configured to, in response to a single request from the bettor device, log in to the first OSBO using the first set of login credentials and to log in to the second OSBO using the second set of login credentials;
the computer system further programmed and configured to retrieve, and store in the digital data storage, combined betting information comprising live betting information and historical betting information, from the first OSBO and second OSBO, the live betting information and historical betting information associated with the bettor; and
the computer system further programmed and configured to transmit at least some of the combined betting information over the data link for display on the bettor device;
whereby the operation of the OSBOs is improved by providing the bettor with a useful and comprehensive view of the bettor's current and historical betting positions and results.

2. The system of claim 1 wherein the bettor device is a smart device, smartphone, or smart tablet programmed and configured to communicate with the computer system.

3. The system of claim 1 wherein the combined betting information comprises event-level data items and bet-level data items.

4. The system of claim 3 wherein the event-level data items comprise: a sport ID, a sports team ID, an opposing team ID, an event date, a point spread, an OSBO fee.

5. The system of claim 3 wherein the event-level data items comprise: a sport ID, a sports team ID, an opposing team ID, an event date, a moneyline, an amount of bought points, a bet duration, the bettor's wager.

6. The system of claim 3 wherein the event-level data items comprise: an event date, a proposition description, and an OSBO fee.

7. The system of claim 3 wherein the bet-level data items comprise: a ticket number, a bet open date, an amount at risk, an amount that can be won, a structure of the event, a bet status, a bet closed date, a gross amount won/lost, a net amount won/lost.

8. The system of claim 1 wherein the computer system is further programmed and configured to communicate over a data link with a game status server and to retrieve and store game status data from the game status server, and to transmit at least some of the game status data for display on the bettor device in response to a request sent to the computer system from the bettor device over the data link.

9. The system of claim 1 wherein the computer system is programmed and configured to:
communicate over a data link with a live-odds server and to retrieve and store live-odds data from the live-odds server, the live-odds data related to at least some of the live betting information;
communicate over a data link with a game status server and to retrieve and store game status data from the game status server, the game status data related to at least some of the live betting information;
calculate an estimated bet value based on at least part of the event-level data, at least part of the bet-level data, at least part of the live-odds data, and at least part of the game status data; and
to transmit the estimated bet value to the bettor device over the data link for display on the bettor device.

10. A method for monitoring performance of sports betting activity of a bettor across a plurality of on-line sports betting operations (OSBOs), comprising the following steps:
receiving and digitally storing a first set of login credentials for a first OSBO, the first set of login credentials associated with the bettor;
receiving and digitally storing a second set of login credentials for a second OSBO, the second set of login credentials associated with the bettor;
in response to a single request from a bettor device, logging in to the first OSBO using the first set of login credentials, retrieving from the first OSBO and digitally storing live betting information and historical betting information, logging in to the second OSBO using the second set of login credentials, and retrieving from the second OSBO and digitally storing live betting information and historical betting information of the bettor on the second OSBO, resulting in stored combined betting information comprising live betting information and historical betting information from the first OSBO and second OSBO; and
transmitting at least some of the combined betting information to the bettor device over a data link for display on the bettor device;
whereby the operation of the OSBOs is improved by providing the bettor with a useful and comprehensive view of the bettor's current and historical betting positions and results.

11. The method of claim 10 wherein the bettor device is a smart device, smartphone, or smart tablet programmed and configured to communicate with the computer system.

12. The method of claim 10 wherein the combined betting information comprises event-level data items and bet-level data items.

13. The method of claim 12 wherein the event-level data items comprise: a sport ID, a sports team ID, an opposing team ID, an event date, a point spread, an OSBO fee.

14. The method of claim 12 wherein the event-level data items comprise: a sport ID, a sports team ID, an opposing team ID, an event date, a moneyline, an amount of bought points, a bet duration, and the bettor's wager.

15. The method of claim 12 wherein the event-level data items comprise: an event date, a proposition description, and an OSBO fee.

16. The method of claim 12 wherein the bet-level data items comprise: a ticket number, a bet open date, an amount at risk, an amount that can be won, a structure of the event, a bet status, a bet closed date, a gross amount won/lost, and a net amount won/lost.

17. The method of claim 10 further comprising the steps of:
receiving and digitally storing game status data from a game status server;
transmitting at least some of the game status data along with at least some of the combined betting information to the bettor device over a data link for display on the bettor device.

18. The method of claim 10 further comprising the steps of:
receiving and digitally storing game status data from a game status server;
receiving and digitally storing live-odds data from a live-odds server;
calculating an estimated bet value based on at least part of the event-level data, at least part of the bet-level data, at least part of the live-odds data, and at least part of the game status data; and
transmitting the estimated bet value along with at least some of the combined betting information to the bettor device over a data link for display on the bettor device.
